(19) United States
(12) Patent Application Publication
(10) Pub. No.: US 2018/0348828 A1
(43) Pub. Date: Dec. 6, 2018

(54) Systems, Methods, and Modular Attachment Devices for Thermal Management of an Electronic Device

(71) Applicant: Motorola Mobility LLC, Chicago, IL (US)

(72) Inventors: Alberto R Cavallaro, Northbrook, IL (US); Charles D. Wood, Highland Park, IL (US); Morris Bowers, Grayslake, IL (US); David Winkler, Spring Grove, IL (US)

(21) Appl. No.: 15/613,978

(22) Filed: Jun. 5, 2017

(51) Int. Cl. G06F 1/20; H04M 1/02

(52) U.S. Cl. CPC G06F 1/203; H04M 1/026

(57) ABSTRACT

An attachment for an electronic device includes a housing. The housing is selectively attachable to an electronic device or electronic device module by one or more coupling devices. At least one thermal energy mitigation device is carried by the housing. At least one thermal energy sensor is optionally carried by the housing. A control circuit of the attachment, or alternatively one or more processors of the electronic device or electronic device module can actuate the thermal energy mitigation device to dissipate thermal energy incident upon the housing, or generated by the electronic device, in response to signals from the thermal energy sensor.

### BACKGROUND

### Technical Field

This disclosure relates generally to electronic devices, and more particularly to thermal management of electronic devices.

### Background Art

Modern portable electronic devices are powerful computing systems. The processors in such devices are more powerful that giant supercomputers of the not too distant past. Unfortunately, the average user does not take advantage of the extent of this processing power and the corresponding capabilities in many situations. In some cases, this is by choice. For example, many users may employ a smartphone only for making voice calls or for sending short text or social media messages. Such tasks require only a fraction of the computing power available within the device.

However, in other cases this is due to physical limitations. As technology develops, users frequently demand for lighter and thinner devices. Housing walls get thinner, as does the available volume within the device. At the same time, the small yet powerful processors within the device generate large amounts of thermal energy when operating at maximum capacity. For this reason, many manufacturers limit processor maximum output operation to a predefined time, such as thirty seconds or less, to ensure that the electronic device does not become too hot. Excess heat can compromise the reliability of interior components, as well as make the device less than comfortable to handle. It would be advantageous to have an improved thermal management system for portable electronic devices, many of which are becoming thinner and lighter.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present disclosure.

FIG. 1 illustrates one explanatory electronic device in accordance with one or more embodiments of the disclosure.

FIG. 2 illustrates one explanatory modular system in accordance with one or more embodiments of the disclosure.

FIG. 3 illustrates another view of one explanatory modular system in accordance with one or more embodiments of the disclosure.

FIG. 4 illustrates another explanatory modular system in accordance with one or more embodiments of the disclosure.

FIG. 5 illustrates one explanatory modular system, with an explanatory attachment detached from an electronic device, in accordance with one or more embodiments of the disclosure.

FIG. 6 illustrates the explanatory modular system of FIG. 5, but with the attachment coupled to the electronic device in accordance with one or more embodiments of the disclosure.

FIG. 7 illustrates another explanatory modular system, with an explanatory attachment detached from an electronic device, in accordance with one or more embodiments of the disclosure.

FIG. 8 illustrates the explanatory modular system of FIG. 7, but with the attachment coupled to the electronic device in accordance with one or more embodiments of the disclosure.

FIG. 9 illustrates another explanatory modular system in accordance with one or more embodiments of the disclosure.

FIG. 10 illustrates a schematic block diagram of one explanatory attachment in accordance with one or more embodiments of the disclosure.

FIG. 11 illustrates another explanatory modular system in accordance with one or more embodiments of the disclosure.

FIG. 12 illustrates another explanatory modular system in accordance with one or more embodiments of the disclosure.

FIG. 13 illustrates another explanatory modular system in accordance with one or more embodiments of the disclosure.

FIG. 14 illustrates another explanatory modular system, with an explanatory attachment detached from an electronic device, in accordance with one or more embodiments of the disclosure.

FIG. 15 illustrates the explanatory modular system of FIG. 14, but with the attachment coupled to the electronic device in accordance with one or more embodiments of the disclosure.

FIG. 16 illustrates a schematic block diagram of the explanatory modular system of FIGS. 14-15.

FIG. 17 illustrates one explanatory method in accordance with one or more embodiments of the disclosure.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present disclosure.

### DETAILED DESCRIPTION OF THE DRAWINGS

Before describing in detail embodiments that are in accordance with the present disclosure, it should be observed that the embodiments reside primarily in combinations of method steps and apparatus components related to thermal management of an electronic device. Any process descriptions or blocks in flow charts should be understood as representing modules, segments, or portions of code that include one or more executable instructions for implementing specific logical functions or steps in the process. Alternate implementations are included, and it will be clear that functions may be executed out of order from that shown or discussed, including substantially concurrently or in reverse order, depending on the functionality involved. Accordingly, the apparatus components and method steps have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

It will be appreciated that embodiments of the disclosure described herein may be comprised of one or more conventional processors and unique stored program instructions that control the one or more processors to implement, in conjunction with certain non-processor circuits, some, most, or all of the functions of thermal management as described herein. The non-processor circuits may include, but are not limited to, a communication bus, a wireless transceiver, signal drivers, buffer circuits, clock circuits, power source circuits, and user input devices. As such, these functions may be interpreted as steps of a method to perform thermal management. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

Embodiments of the disclosure are now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.” Relational terms such as first and second, top and bottom, and the like may be used solely to distinguish one entity or action from another entity or action without necessarily requiring or implying any actual such relationship or order between such entities or actions. As used herein, components may be “operatively coupled” when information can be sent between such components, even though there may be one or more intermediate or intervening components between, or along the connection path. The terms “substantially” and “about” are used to refer to dimensions, orientations, or alignments inclusive of manufacturing tolerances. Thus, a “substantially orthogonal” angle with a manufacturing tolerance of plus or minus two degrees would include all angles between 88 and 92, inclusive. Also, reference designators shown herein in parenthesis indicate components shown in a figure other than the one in discussion. For example, talking about a device (10) while discussing figure A would refer to an element, 10, shown in figure other than figure A.

As noted above, processors and other components disposed within portable electronic devices, such as smartphones, tablet computers, gaming devices, media players, and so forth, generate a lot of heat. Moreover, these components tend to be very small. Thus, while the amount of heat generated may not be extreme compared to, say, an oven or furnace, the fact that the heat is concentrated in a small location makes it problematic. For example, a central processor operating in a smartphone at a maximum level may generate nine watts. If this heat is not dissipated, it can cause damage to the die, surrounding components, or other circuits. Moreover, it can make the device less than comfortable to handle.

For this reason, most manufacturers limit output power of microprocessors and other high output power components. In the typical smartphone, for example, a manufacturer may limit the maximum output power to be generated for a predefined time such as thirty seconds or less. A maximum output power of nine watts might be scaled back to something on the order of four watts after thirty seconds of full performance operation for instance. This prevents damage to the die of the processor or other semiconductor component, as well as protecting the battery chemistry from compromised reliability. The reduction in power also prevents the housing of the device from exceeding the ambient temperature by more than a few degrees centigrade.

The accompanying reduction in performance comes at a cost, namely, that the speed and number of cores in the processor is reduced, thereby causing complex computational tasks to take longer. The user experience is reduced when the device seems to operate slower, despite having the “latest and greatest” processor inside.

Prior art attempts to solve the problem include incorporating thermally conductive layers within the device that are physically coupled to the microprocessor or other heat generating component. These devices work as heat spreaders or thermal conduits in an attempt to spread the thermal energy over a larger area in an effort to dissipate through radiation. Such solutions have only limited success because radiation is a relatively inefficient, compared to conduction or convection, way of dissipating heat. It is not possible to include more efficient systems, such as blowers and condensers, because as noted above the form factors of portable electronic devices are becoming thinner, smaller, and lighter. Accordingly, there simply is no room for such components.

Advantageously, embodiments of the disclosure provide an attachment that can be selectively coupled to an electronic device, an electronic device module, or between one or more electronic device modules. The attachment can be incorporated into a modular device design in one or more embodiments so that the attachment can be used only when needed. For example, when a user of an electronic device knows that optimal performance is needed, or simply wants the “most the device can give,” the user may couple the attachment to the electronic device. By contrast, when performing more mundane or routine tasks, the user may detach the attachment from the electronic device to return the electronic device to its original form factor.

In one or more embodiments, the electronic device or electronic device module includes a display, user interface such as a touchscreen, and other components including an energy storage device or battery, one or more processors or control circuits, a wireless transceiver, and so forth. In one or more embodiments, the attachment is selectively attachable to the electronic device or electronic device module and includes at least one thermal energy mitigation device such as a fan, condenser, heat pipe, heat sink, radiation fin, or convection tube. Other examples of thermal energy mitigation devices will be obvious to those of ordinary skill in the art having the benefit of this disclosure.

In one or more embodiments, the modular system includes at least one thermal energy sensor. In one embodiment, the thermal energy sensor is disposed in the attachment, and is carried by a housing of the attachment. In another embodiment, the at least one thermal energy sensor is disposed within the electronic device, with signals from the thermal energy sensor being delivered to the attachment via a communication bus or electrical connection between the attachment and the electronic device. Of course, a combination of the two can be used as well. Examples of thermal energy sensors include thermistors, thermocouples, thermometers, resistive temperature detectors, silicon band gap temperature sensors, integrated circuit temperature sensors, bimetallic thermostats, infrared signal sensors, and so forth. Still other examples of thermal energy sensors will be obvious to those of ordinary skill in the art having the benefit of this disclosure.

In one or more embodiments, the attachment includes a control circuit. The control circuit is operable with the energy mitigation device and the thermal energy sensor, be it in the attachment, in the electronic device, or both. The control circuit is operable to cause the thermal energy mitigation device to dissipate thermal energy that is incident upon the housing of the electronic device. Illustrating by example, if the microprocessor of the electronic device is generating large amounts of thermal energy, thereby causing the housing of the electronic device to warm, this will be sensed by the thermal energy sensor. In one or more embodiments the control circuit will cause the thermal energy mitigation device to dissipate this thermal energy in response to signals from the thermal energy sensor. The control circuit might cause, for instance, a fan to actuate to draw air in through a major face of the attachment, across a major face of the electronic device, and out through minor faces of the attachment to cool the housing surface. Other examples will be described in more detail below, and still other examples will be obvious to those of ordinary skill in the art having the benefit of this disclosure.

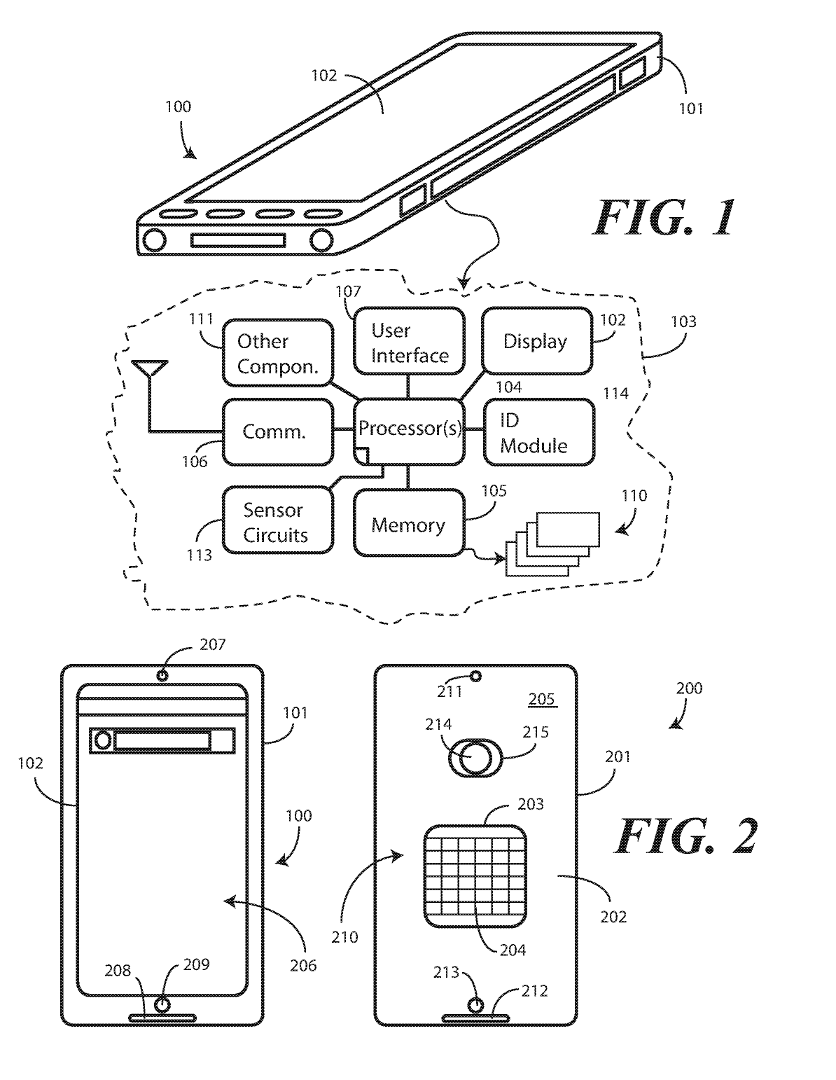

Turning now to FIG. 1, illustrated therein is one explanatory electronic device 100 in accordance with one or more embodiments of the disclosure. The electronic device 100 of FIG. 1 is shown as a portable electronic device. As will be described in more detail below, in one or more embodiments the electronic device 100 is selectively attachable and detachable from an attachment that is operable to dissipate thermal energy incident upon the housing 101 of the electronic device 100. Moreover, the electronic device 100 of FIG. 1 is shown illustratively as a smartphone. For simplicity, this embodiment will be described as an illustrative example. However, the electronic device 100 can take other forms as well, including as a palm top computer, a gaming device, a laptop computer, a multimedia player, and so forth. Still other examples of electronic devices will be obvious to those of ordinary skill in the art having the benefit of this disclosure.

In one or more embodiments, the electronic device 100 includes a housing 101. The housing 101 can include one or more housing portions, such as a first housing portion and a second housing portion. In this illustrative embodiment, the housing 101 is disposed about the periphery of a display 102, thereby defining a major face of the electronic device 100.

A block diagram schematic 103 of the electronic device 100 is also shown in FIG. 1. In one embodiment, the electronic device 100 includes one or more processors 104. The one or more processors 104 are operable with the display 102 and other components of the electronic device 100. The one or more processors 104 can include a microprocessor, a group of processing components, one or more ASICs, programmable logic, or other type of processing device. The one or more processors 104 can be operable with the various components of the electronic device 100. The one or more processors 104 can be configured to process and execute executable software code to perform the various functions of the electronic device 100.

A storage device, such as memory 105, can optionally store the executable software code used by the one or more processors 104 during operation. The memory 105 may include either or both static and dynamic memory components, may be used for storing both embedded code and user data. The software code can embody program instructions and methods to operate the various functions of the electronic device 100, and also to execute software or firmware applications and modules. The one or more processors 104 can execute this software or firmware, and/or interact with modules, to provide device functionality.

As noted, in one or more embodiments the electronic device 100 includes a display 102, which may optionally be touch-sensitive. In one embodiment where the display 102 is touch-sensitive, the display 102 can serve as a primary user interface 107 of the electronic device 100. Users can deliver user input to the display 102 of such an embodiment by delivering touch input from a finger, stylus, or other objects disposed proximately with the display. In one embodiment, the display 102 is configured as an organic light emitting diode (OLED) display. However, it should be noted that other types of displays would be obvious to those of ordinary skill in the art having the benefit of this disclosure. In one embodiment, the display 102 includes an electroluminescent layer or light-emitting diode (LED) backlighting layer disposed beneath the display 102 to project light through the display 102. The display 102 can adaptively present text, graphics, images, user actuation targets, data, and controls along the display surface.

In this illustrative embodiment, the electronic device 100 also includes an optional communication circuit 106 that can be configured for wired or wireless communication with one or more other devices or networks. The networks can include a wide area network, a local area network, and/or personal area network. Examples of wide area networks include GSM, CDMA, W-CDMA, CDMA-2000, iDEN, TDMA, 2.5 Generation 3GPP GSM networks, 3rd Generation 3GPP WCDMA networks, 3GPP Long Term Evolution (LTE) networks, and 3GPP2 CDMA communication networks, UMTS networks, E-UTRA networks, GPRS networks, iDEN networks, and other networks.

The communication circuit 106 may also utilize wireless technology for communication, such as, but are not limited to, peer-to-peer or ad hoc communications such as HomeRF, Bluetooth and IEEE 802.11 (a, b, g or n); and other forms of wireless communication such as infrared technology. The communication circuit 106 can include wireless communication circuitry, one of a receiver, a transmitter, or transceiver, and one or more antennas.

The one or more processors 104 can be responsible for performing the primary functions of the electronic device 100. For example, in one embodiment the one or more processors 104 comprise one or more circuits operable with one or more user interface devices, which can include the display 102, to present presentation information to a user. The executable software code used by the one or more processors 104 can be configured as one or more modules 110 that are operable with the one or more processors 104. Such modules 110 can store instructions, control algorithms, and so forth. While these modules 110 are shown as software stored in the memory 105, they can be hardware components or firmware components integrated into the one or more processors 104 as well.

Other components 111 can be included with the electronic device 100. The other components 111 can be operable with the one or more processors 104 and can include input and output components associated with a user interface 107, such as power inputs and outputs, audio inputs and outputs, and/or mechanical inputs and outputs. The other components 111 can include output components such as video, audio, and/or mechanical outputs. For example, the output components may include a video output component or auxiliary devices including a cathode ray tube, liquid crystal display, plasma display, incandescent light, fluorescent light, front or rear projection display, and light emitting diode indicator. Other examples of output components include audio output components such as a loudspeaker disposed behind a speaker port or other alarms and/or buzzers and/or a mechanical output component such as vibrating or motion-based mechanisms. Still other components will be obvious to those of ordinary skill in the art having the benefit of this disclosure.

One or more sensor circuits 113 are operable with the one or more processors 104 in one or more embodiments. These sensor circuits 113 can include one or more thermal energy sensors 112. As noted above, the one or more thermal energy sensors 112 can detect the amount of thermal energy being generated by one or more components of the electronic device 100. Examples of thermal energy sensors include thermistors, thermocouples, thermometers, resistive temperature detectors, silicon band gap temperature sensors, integrated circuit temperature sensors, bimetallic thermostats, infrared signal sensors, and so forth. Still other examples of thermal energy sensors will be obvious to those of ordinary skill in the art having the benefit of this disclosure.

The one or more sensor circuits 113 can also be configured to sense or determine physical parameters indicative of conditions in an environment about the electronic device 100. Illustrating by example, the physical sensors can include devices for determining information such as motion, bearing, location, acceleration, orientation, proximity to people and other objects, incident light amounts, and so forth. The one or more sensor circuits 113 can include various combinations of microphones, location detectors, motion sensors, physical parameter sensors, temperature sensors, barometers, proximity sensor components, proximity detector components, wellness sensors, touch sensors, cameras, audio capture devices, and so forth.

The one or more sensor circuits 113 can also include a touch pad sensor, a touch screen sensor, a capacitive touch sensor, and one or more switches. The one or more sensor circuits 113 can also include audio sensors and video sensors (such as a camera). The one or more sensor circuits 113 can also include motion detectors, such as one or more accelerometers or gyroscopes. The motion detectors can detect movement, and direction of movement, of the electronic device 100 by a user. The one or more sensor circuits 113 can also be used to detect gestures. For example, the other one or more sensor circuits 113 can include one or more proximity sensors that detect the gesture of a user waving a hand above the display 102. In yet another embodiment, the accelerometer can detect gesture input from a user lifting, shaking, or otherwise deliberately moving the electronic device 100. It should be clear to those of ordinary skill in the art having the benefit of this disclosure that additional sensors can be included as well. Moreover, other types of sensor circuits 113 will be obvious to those of ordinary skill in the art having the benefit of this disclosure.

An optional identification module 114 can be configured to determine whether an attachment, the details of which will be described below with reference to subsequent figures, is coupled to the electronic device 100. In one or more embodiments, the identification module 114 can detect not only whether an attachment is coupled to the electronic device 100, but the type of attachment as well. For example, where the attachment magnetically couples to the electronic device 100, the identification module 114 can determine the number and/or placement of magnetic couplings to detect the type of attachment. Where the attachment mechanically couples to the electronic device 100, in one embodiment the identification module 114 is operable with multiple mechanical connectors to determine which are engaged to identify the attachment. Where the attachment is electrically coupled to the electronic device 100, in one embodiment the identification module 114 can identify the attachment by exchanging electrical signals with a control circuit of the attachment. Other examples of identification techniques will be obvious to those of ordinary skill in the art having the benefit of this disclosure.

It is to be understood that FIG. 1 is provided for illustrative purposes only and for illustrating components of one electronic device 100 in accordance with embodiments of the disclosure, and is not intended to be a complete schematic diagram of the various components required for an electronic device. Therefore, other electronic devices in accordance with embodiments of the disclosure may include various other components not shown in FIG. 1, or may include a combination of two or more components or a division of a particular component into two or more separate components, and still be within the scope of the present disclosure.

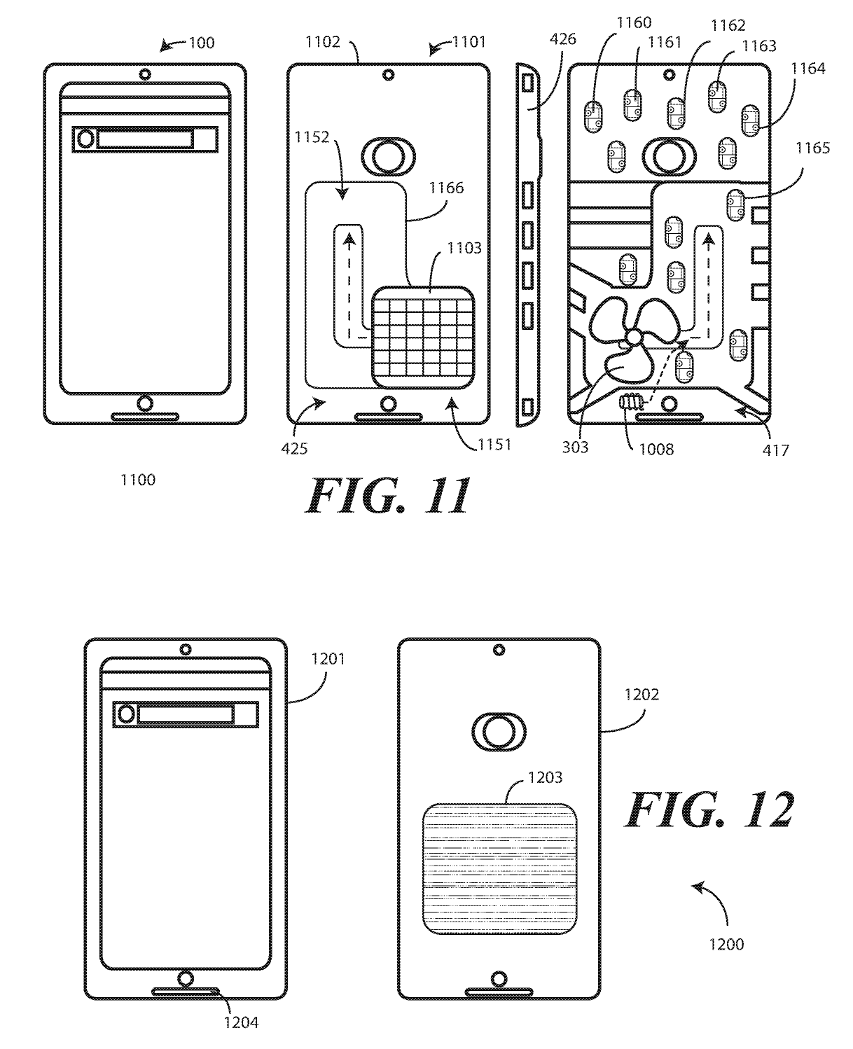

Turning now to FIG. 2, illustrated therein is one explanatory modular system 200 in accordance with one or more embodiments of the disclosure. In one or more embodiments, the modular system 200 includes one of an electronic device 100 or an electronic device module (described in more detail below with reference to FIGS. 12-15) and an attachment 201. In one or more embodiments, the attachment 201 can be selectively attached to, or detached from, the electronic device 100 or an electronic device module.

As the principal components of the electronic device 100 were explained above with reference to FIG. 1, attention will now be directed to the attachment 201. In one or more embodiments, the attachment includes a housing 202. In one or more embodiments, the housing 202 is selectively attachable to the electronic device 100 by one or more coupling devices, examples of which will be explained in more detail below with reference to FIG. 4.

In one or more embodiments, the housing 202 of the attachment 201 can be mechanically attached to the electronic device 100 or an electronic device module. For example, mechanical clasps for the attachment 201 can be configured to wrap about, or engage, the housing 101 of the electronic device 100, thereby retaining the attachment 201 against a surface of the housing 101. Such clasps permit the attachment 201 to be completely detached from the electronic device 100 and treated as an accessory.

In another embodiment, when not in use, the attachment 201 may be mechanically retained to the electronic device 100 by a lanyard or similar device. Such a configuration helps to prevent inadvertent loss of the attachment 201 when detached from the housing 101 of the electronic device 100.

In yet another embodiment, the attachment 201 may be coupled to the electronic device 100 by a hook and slider mechanism so as to be detachable from the housing 101 yet non-detachable from the electronic device 100 itself. Other attachment mechanisms include magnetic couplings, snaps, protective casing couplings, boot couplings, static attachment connectors, vertical locators, horizontal locators, and the like. Some of these various mechanical configurations will be illustrated in more detail below. These mechanical embodiments are intended to be illustrative only. As an alternate to mechanical attachments, the attachment 201 can be attached to the housing 101 using static adhesion, mechanical suction, or in other ways.

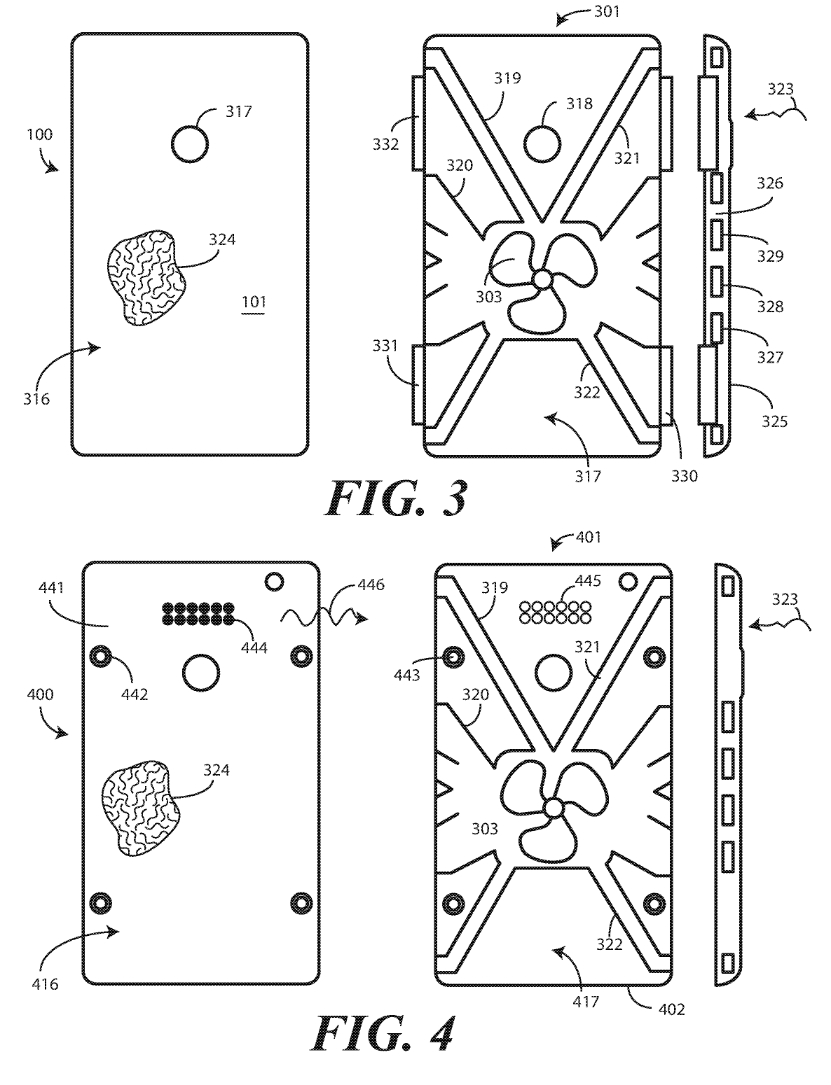

In one or more embodiments, the attachment 201 comprises at least one thermal energy mitigation device 203. Examples of thermal energy mitigation devices 203 include a fan, condenser, heat pipe, heat sink, radiation fin, or convection tube. Other examples of thermal energy mitigation devices 203 will be obvious to those of ordinary skill in the art having the benefit of this disclosure. In this illustrative embodiment, the thermal energy mitigation device 203 comprises a fan (shown below with reference to FIG. 3), carried by the housing 202, and aligned with an aperture in a major face 205 of the attachment 201. In this illustrative embodiment, to prevent user contact with the fan, the fan is disposed behind a grille 204.

In some embodiments, the attachment 201 will include only the thermal energy mitigation device 203, which is carried by the housing 202. In other embodiments, such as those described with reference to FIGS. 10-11 below for example, the attachment 201 can include mechanical actuators, control circuits, thermal energy sensors, and other components.

In one or more embodiments, the electronic device 100 and the attachment 201 can even include complementary or common components. For example, the electronic device 100 and attachment 201 may both include components for receiving user input, such as loudspeakers, microphones, earpiece speakers, and the like. When such components are included in the attachment 201 and the electronic device 100, a user can—for example—deliver voice input to a microphone disposed in the electronic device 100 or the attachment 201. An electrical connection therebetween can deliver user input received by the attachment 201 to the electronic device 100.

In the illustrative embodiment of FIG. 2, some features visible in the front side 206 of the electronic device 100 include an earpiece speaker 207, a loudspeaker 208, a microphone 209, and of course, the display 102. To facilitate optimal interaction with a user, in one or more embodiments the back side 210 of the attachment 201 can also include an earpiece speaker 211, a loudspeaker 212, and microphone 213. In an alternative embodiment, the attachment 201 may simply include apertures to port or channel acoustic, visible, or other signals to an earpiece speaker, microphone, or camera disposed on the back side of the electronic device 100.

The attachment 201 can be equipped with additional features as well. Illustrating by example, in one or more embodiments the attachment 201 can include a camera 214 or other device to enhance electronic device operation. The camera 214 can be carried on the housing 202 of the attachment 201 to provide an enhanced feature for the electronic device 100 in one or more embodiments. In other embodiments where the electronic device 100 may include its own rear-facing camera, the camera 214 of the attachment 201 may be accompanied by an aperture 215 to allow a sight line for the rear-facing camera of the electronic device 100. These various options are included to demonstrate the numerous features and devices that can be incorporated into the attachment 201 beyond just the thermal energy mitigation device 203. However, as noted above, in some embodiments the attachment 201 will carry only the thermal energy mitigation device 203. The various combinations and permutations of features to include within the attachment 201 beyond the thermal energy mitigation device 203 will be obvious to those of ordinary skill in the art having the benefit of this disclosure.

Turning now to FIGS. 3 and 4, illustrated therein are examples of various ways in which an attachment 301 can be coupled to an electronic device 100 in accordance with one or more embodiments of the disclosure. As noted above, in one or more embodiments of the disclosure, the attachment 301 can be coupled to the electronic device 100 by mechanical, magnetic, suction, static, and other techniques.

Beginning with FIG. 3, illustrated therein is the back side 316 of the electronic device 100 and the front side 317 of one explanatory attachment 301 configured in accordance with one or more embodiments of the disclosure. The back side 316 of the electronic device 100 defines a major face of the electronic device 100. The front side 317 of the attachment 301, which defines a major face of the attachment 301, can be selectively attachable to this major face of the electronic device 100 in one or more embodiments.

As shown in FIG. 3, the back side 316 of the electronic device 100 includes a rear-facing camera 317. To reduce the number of components and to simplify construction of the attachment 301, in this illustrative embodiment the attachment 301 includes an aperture 318 through which light may pass to the rear-facing camera 317 when the attachment 301 is coupled to the back side 316 of the electronic device 100.

As before, the attachment 301 includes a housing 302 that carries a thermal energy mitigation device, which is illustrated here as a fan 303. The housing 302 of this illustrative embodiment defines one or more ducts 319,320,321,322 through which the fan may draw or push air 323 to dissipate thermal energy 324 incident upon the housing 101 of the electronic device 100.

Illustrating by example, the back side of the attachment 301, i.e., the major face opposite the front side 317 of the attachment 301, defines a major face 325 of the attachment 301. The faces of the housing 302 spanning the front side 317 and the back side of the attachment 301 define minor faces 326 of the attachment. In one or more embodiments, the fan 313 is operable to draw the air 323 into the housing 302 through the major face 325 and out of the housing 302, through the ducts 319,320,321,322. This causes the air 323 to pass along the back side 316 of the electronic device 100 to dissipate the thermal energy 324. The fan 313 then pushes the air 323 out one or more ports 327,328,329 in the minor faces 326 of the housing 302 in this illustrative embodiment. Other techniques for dissipating the thermal energy 324 will be described below with reference to subsequent figures.

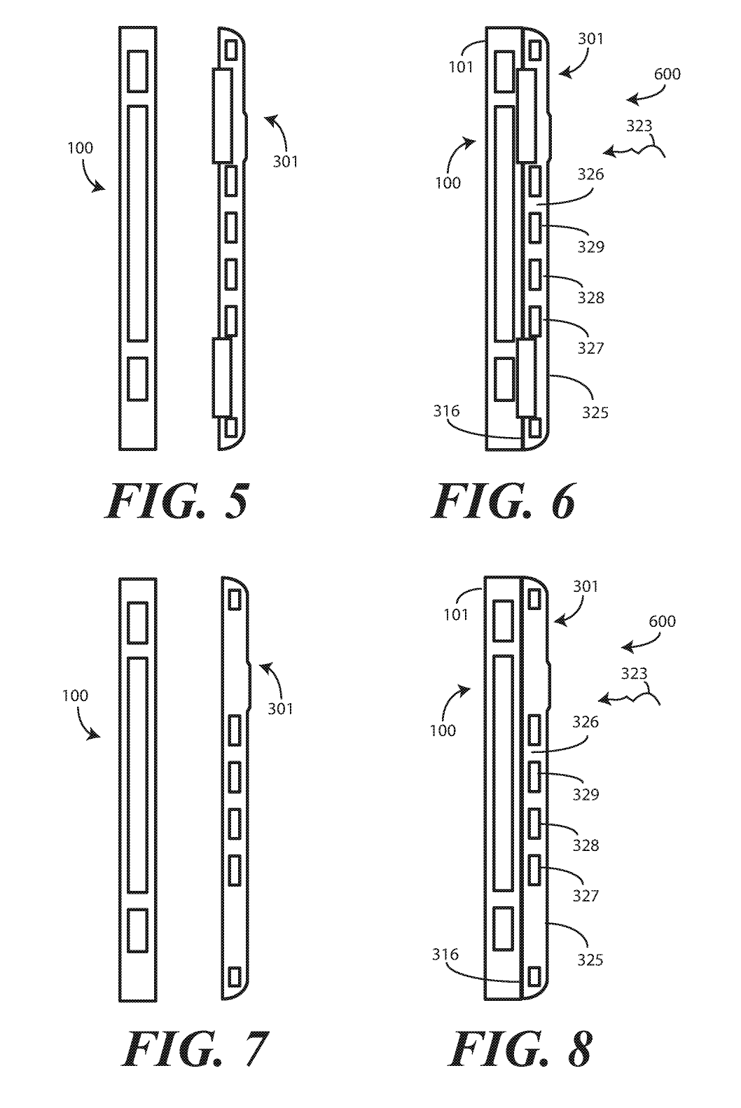

In one or more embodiments, the housing 302 of the attachment 301 can be mechanically attached to the electronic device 100 or an electronic device module by one or more coupling devices. In this illustrative embodiment, the coupling devices comprise mechanical clasps 330,331,332 that are configured to wrap about, or engage, the housing 101 of the electronic device 100, thereby retaining the attachment 301 against the major surface defined by the back side 316 of the housing 101. Such mechanical clasps 330,331,332 permit the attachment 301 to be completely detached from the electronic device 100 and treated as a separate accessory. In FIG. 5, the attachment 301 is shown detached from the electronic device 100, while in FIG. 6 the attachment 301 is shown attached to the electronic device 100 to form a modular system 600.

Turning now to FIG. 4, another coupling system is shown. As shown in FIG. 4, a back side 416 of another electronic device 400 is selectively attachable to a front side 417 of another explanatory attachment 401 configured in accordance with one or more embodiments of the disclosure. As with the embodiment of FIG. 3, the attachment 401 on FIG. 4 includes a housing 402 that carries a thermal energy mitigation device, which is illustrated here as a fan 303. The housing 402 of this illustrative embodiment defines one or more ducts 319,320,321,322 through which the fan may draw or push air 323 to dissipate thermal energy 324 incident upon the housing 441 of the electronic device 400.

In the illustrative embodiment of FIG. 4, the back side 416 of the electronic device 400 includes one or more alignment features 442 configured and placed to mate with complementary mating features 443 on the front side 417 of the attachment 401. In one or more embodiments, the alignment features 442 and complementary mating features 443 are magnetic such that the front side 417 of the attachment 401 can be magnetically adhered to the back side 416 of the electronic device 400. As noted above, in addition to the mechanical coupling described above with reference to FIG. 3, and the magnetic coupling described here, attachments configured in accordance with one or more embodiments of the disclosure can be coupled to electronic devices in other ways as well. These include snaps, protective casing couplings, boot couplings, static attachment connectors, vertical locators, horizontal locators, static adhesion devices, mechanical suction devices, or other devices. In FIG. 7, the attachment 401 is shown detached from the electronic device 400, while in FIG. 8 the attachment 401 is shown attached to the electronic device 400 to form a modular system 800.

Turning now back to FIG. 4, to further illustrated the flexibility with which attachments can be designed in accordance with embodiments of the disclosure, in one embodiment the back side 416 of the electronic device 400 includes a connector array 444. The connector array 444 is located and configured to mate with a mating connector array 445 on the front side 417 of the attachment 401. Electrical signals 446 can be delivered between the electronic device 400 and the attachment 401 using the connector array 444 and the mating connector array 445.

Illustrating by example, in one or more embodiments the one or more processors (104) of the electronic device 400 can selectively actuate the thermal energy mitigation device to dissipate thermal energy incident upon the housing 441 of the electronic device 400 in one or more embodiments. In one or more embodiments, the one or more processors (104) of the electronic device 400 are operable to selectively actuate the at least one thermal energy mitigation device as a function of one of an operating mode of the electronic device 400 or an application operating on the one or more processors (104) for instance.

In another application, where the electronic device 400 includes a temperature sensor, electrical signals 446 from the temperature sensor indicating that the thermal energy 324 exceeds a predefined threshold can be delivered to the attachment 401. Alternatively, the electrical signals 446 may indicate that a temperature of a predefined component of the electronic device 400, e.g., the one or more processors (104), exceed another predefined threshold. In either or both cases, the fan 303 can then be actuated to dissipate the thermal energy 324 incident upon the housing 441 of the electronic device 400 in response to the electrical signals 446.

Regardless of whether the electronic device 400 includes a thermal energy sensor, the electrical signals 446 can be used in other ways as well. For example, when a predefined application is operating in the electronic device 400 that requires large amounts of processing power, the one or more processors (104) of the electronic device 400 may actuate, or request actuation of, the fan 303 using the electrical signals 446. The fan 303 can then dissipate the thermal energy 324 incident upon the housing 441 of the electronic device 400 in response to the electrical signals 446 from the one or more processors (104).

Similarly, when the electronic device 400 is operating in a predefined mode of operation, such as a communication mode that requires internal components to run at high capacity requiring large amounts of processing power, the one or more processors (104) of the electronic device 400 may actuate, or request actuation of, the fan 303 using the electrical signals 446. The fan 303 can then dissipate the thermal energy 324 incident upon the housing 441 of the electronic device 400 in response to the electrical signals 446 from the one or more processors (104). Other uses for the electrical signals 446 to cause the fan 303 to dissipate thermal energy 324 will be obvious to those of ordinary skill in the art having the benefit of this disclosure.

Turning now briefly to FIGS. 6 and 8, in either modular system 600,800, the attachment 301,401 is configured to dissipate thermal energy (324) incident along the housing 101,441 of the electronic device 100,400. In each embodiment, the fan (303) draws air 323 into a major face 325,825 of the attachment 301,401, through ducts (319,320,321,322) defined in the housing 302,402 of the attachment 301,401, across the back side 316,416 of the electronic device 100,400, and then out ports 327,328,329 in minor faces 326,826 of each attachment 301,401.

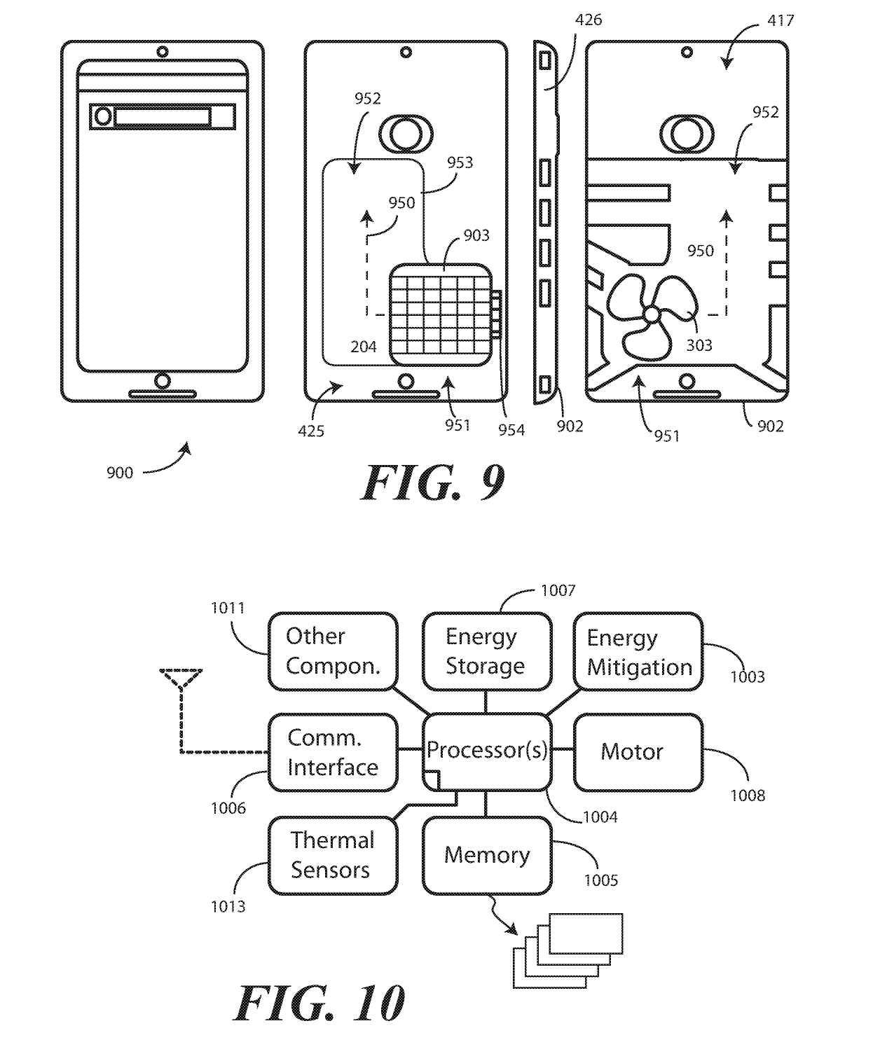

Turning now to FIG. 9, illustrated therein is another modular system 900 configured in accordance with one or more embodiments of the disclosure. In this illustrative embodiment, the modular system 900 includes the electronic device 100 and another attachment 901. A first major face 417 of the attachment 901, a second major face 425 of the attachment 901, and a minor face 426 of the attachment 901 are shown in FIG. 9. As before, the attachment 901 can be selectively attached to, or detached from, the electronic device 100 or an electronic device module similar to that shown above in FIGS. 6 and 8.

In one or more embodiments, the attachment 901 includes a housing 902. In one or more embodiments, the housing 902 is selectively attachable to the electronic device 100 by one or more coupling devices. As before, the attachment 901 comprises at least one thermal energy mitigation device 903. In this illustrative embodiment, the thermal energy mitigation device 903 comprises a fan 303, carried by the housing 902, and disposed behind a grille 204. The embodiment of FIG. 9 differs from previous embodiments in that rather than being stationary, in this illustrative embodiment the fan 303 is moveable 950 between a first location 951 and a second location 952.

Embodiments of the disclosure contemplate that different components within the electronic device 100, e.g., the communication circuit (106) or the one or more processors (104) or other components, will get hot at different times. For example, in a particular operating mode or when operating a particular application, the one or more processors (104) may generate the most thermal energy within the electronic device 100. By contrast, when sending and receiving large amounts of data, the communication circuit (106) may generate a greater amount of heat relative to the other components within the electronic device. When charging, an energy storage device or battery may generate the most heat. Advantageously, making the fan 303 moveable 950 between the first location 951 and the second location 952 allows maximum thermal dissipation, which is generally just beneath the fan 303, to be adjusted to achieve maximum thermal mitigation benefit.

In this illustrative embodiment, the fan 303 is mounted within a track 953. The fan 303 can be mounted within the track 953 on rails, sliders, in recesses, or by other techniques. In this illustrative embodiment, the thermal energy mitigation device includes a graspable surface 954 with which a user may translate the fan 303 between the first location 951 and the second location 952, or anywhere in between. While the track 953 is configured as an L-shape for illustration, it can be configured in various shapes to cover various portions of the rear major face of the electronic device 100. In one or more embodiments frictional components are included within the track 953 to retain the fan 303 at a predefined location selected by a user.

As noted above, in more basic embodiments attachments configured in accordance with one or more embodiments of the disclosure can include essentially only a housing, thermal energy mitigation device, couplers to couple the attachment to an electronic device, and optionally electrical couplers with which the thermal energy mitigation device can be actuated. However, embodiments of the disclosure are not so limited.

Turning now to FIG. 10, illustrated therein are additional components that may be included in attachments configured in accordance with one or more embodiments of the disclosure. The components can be included in various combinations, with some attachments including more components, while other attachments include fewer components, and so forth. Said differently, FIG. 10 shows only one explanatory component group forming part of an environment within which aspects of the present disclosure may be implemented. It will be appreciated that additional or alternative components may be used in a given implementation depending upon user preference, component availability, price point, and other considerations. All or some of the components communicate with one another by way of one or more shared or dedicated internal communication links, such as an internal bus.

In one or more embodiments, an attachment can include, in addition to a thermal energy mitigation device 1003, a control circuit 1004, a memory 1005, a communication interface 1006, one or more thermal energy sensors 1013, an energy source 1007 or storage device, one or more other components 1011, and a mechanical actuator 1008 such as a motor.

The control circuit 1004 may be any of a microprocessor, microcomputer, application-specific integrated circuit, or the like, and is operable with the thermal energy mitigation device 1003 and the one or more thermal energy sensors 1013 (where included) in one or more embodiments. In one or more embodiments, the control circuit 1004 is operable to independently actuate the thermal energy mitigation device 1303 in response to signals from the one or more thermal energy sensors 1013.

The memory 1005 may reside on the same integrated circuit as the control circuit 1004, or alternatively may be a separate component. The memory 1005 may include a random access memory (i.e., Synchronous Dynamic Random Access Memory (SDRAM), Dynamic Random Access Memory (DRAM), RAMBUS Dynamic Random Access Memory (RDRM) or any other type of random access memory device). Additionally or alternatively, the memory 1005 may include a read only memory (i.e., a hard drive, flash memory or any other desired type of memory device).

Information that is stored by the memory 1005 can include program code associated with operating the thermal energy mitigation device 1003, receiving information from the one or more thermal energy sensors 1013, or to other informational data, e.g., program parameters, process data, etc. The operation of the control circuit 1004 can be in accordance with executable instructions stored in a non-transitory computer readable medium (e.g., memory 1005) to control basic functions of the attachment and its thermal energy mitigation device 1003. Such functions may include, for example, turning the thermal energy mitigation device 1003 ON and OFF, moving the thermal energy mitigation device 1003 between a first location and a second location, and other operations as well.

In one or more embodiments, the control circuit 1004 is programmed to interact with the other components of the attachment to perform certain functions. The control circuit 1004 may include or implement various modules and execute programs for initiating different activities. For instance, as the control circuit 1004 is operable with the at least one thermal energy mitigation device 1003 and the at least one thermal energy sensor 1013, in one or more embodiments the control circuit 1004 can cause the at least one thermal energy mitigation device 1003 to dissipate thermal energy incident upon the housing of the electronic device to which the attachment is coupled in response to signals from the at least one thermal energy sensor 1013.

The communication interface 1006 can be used for communication with an electronic device with which an attachment including this component group is attached. For example, where an electronic device includes a connector array that mates with a mating connector array of the attachment, the communication interface 1006 can be responsible for sending and receiving electrical signals between the electronic device and the attachment using the connector array and the mating connector array. These electrical signals can include signals from a temperature sensor indicating that the thermal energy within the electronic device exceeds a predefined threshold, that a temperature of a predefined component of the electronic device exceeds another predefined threshold, whether a predefined application is operating in the electronic device that requires large amounts of processing power, whether the electronic device is operating in a predefined mode of operation that requires internal components to run at high capacity requiring large amounts of processing power, and so forth. Other electrical signals handled by the communication interface 1006 will be obvious to those of ordinary skill in the art having the benefit of this disclosure.

In one or more embodiments, the attachment may include its own energy source 1007 with which the thermal energy mitigation device 1003, the control circuit 1004, and/or other components can be powered. The inclusion of a dedicated energy source 1007 prevents draining the energy source of the electronic device to energize the thermal energy mitigation device 1003, thereby extending runtime of the electronic device when the attachment is coupled thereto. The energy source 1007 can include a battery or fuel cell for providing power to the thermal energy mitigation device 1003 and its corresponding components.

The one or more thermal energy sensors 1013 can include any of thermistors, thermocouples, thermometers, resistive temperature detectors, silicon band gap temperature sensors, integrated circuit temperature sensors, bimetallic thermostats, infrared signal sensors, and so forth. Still other examples of thermal energy sensors will be obvious to those of ordinary skill in the art having the benefit of this disclosure. In one embodiment, the one or more thermal energy sensors 1013 comprise infrared receivers that receive infrared signals from thermal energy emanating from the electronic device.

In one or more embodiments, a mechanical actuator 1008, such as a motor, is included in the attachment. In one or more embodiments, the mechanical actuator 1008, which is carried by the housing of the attachment, can be actuated by the control circuit 1004 to translate the thermal energy mitigation device 1003 between a first location and a second location in response to signals from the one or more thermal energy sensors 1013. Recall from above that in one or more embodiments the thermal energy mitigation device 1003 is moveable between at least a first location and at least a second location to allow for maximum efficiency in thermal energy dissipation. While the embodiment of FIG. 9, which allowed manual manipulation of a fan (303), works well in practice, it does require a user to deduce—or guess—where the warmest spots of the electronic device are located. Where the attachment includes multiple thermal energy sensors 1013, in one embodiment the control circuit 1004 can actuate the mechanical actuator to automatically move the thermal energy mitigation device 1003 to the location along the electronic device where it can be most effective.

Turning now to FIG. 11, illustrated therein is another modular system 1100 configured in accordance with one or more embodiments of the disclosure. In this illustrative embodiment, the modular system 1100 includes the electronic device 100 and another attachment 1101. The attachment 1101 includes the control circuit (1004) that can actuate a mechanical actuator 1008 to selectively translate the thermal energy mitigation device 1103, illustrated here as a fan 303, between at least a first location 1151 and a second location 1152. As before, a first major face 417 of the attachment 1101, a second major face 425 of the attachment 1101, and a minor face 426 of the attachment 1101 are shown in FIG. 11. The attachment 1101 can be selectively attached to, or detached from, the electronic device 100 or an electronic device module as previously described.

Additionally, in this embodiment the attachment 1101 includes a several thermal energy sensors 1160,1161,1162,1163. In this embodiment, the thermal energy sensors 1160,1161,1162,1163 are distributed across the first major face 417 of the housing 1102 to define an array 1164. Each thermal energy sensor 1160,1161,1162,1163 is operable with the control circuit (1004) to deliver signals to the control circuit (1004) indicating how much thermal energy each thermal energy sensor 1160,1161,1162,1163 is receiving. In effect, the array 1164 of thermal energy sensors 1160,1161,1162,1163 detect where along the first major face 417 a highest thermal energy amount occurs.

Based upon this information, the control circuit (1004) can cause the thermal energy mitigation device 1103 to move from a first location 1151, where the thermal energy amount is lower, to a second location 1152 that is collocated with a particular thermal energy sensor 1165 detecting a highest thermal energy amount. Said differently, based upon signals coming from the array 1164 of thermal energy sensors 1160,1161,1162,1163, and in particular from a thermal energy sensor 1155 detecting a highest thermal energy amount, the control circuit (1004) can cause the mechanical actuator 1008 to move the fan 303 to be collocated with the thermal energy sensor 1165 detecting the highest thermal energy amount to provide a most efficient and effective cooling benefit to the electronic device 100. Embodiments of the disclosure contemplate that only a subset of components, e.g., the primary processor, an auxiliary processor, a communication circuit, etc., will generate large amounts of thermal energy. Accordingly, the placement of the array 1164 of thermal energy sensors 1160,1161,1162,1163 and/or the shape and location of the track 1166 can be such that particular thermal energy sensors 1165 can be collocated with a particular component of the electronic device 100, and such that the fan 303 can pass atop the location where that particular component is disposed for optimal cooling.

Moreover, embodiments of the disclosure contemplate that different components within the electronic device 100 will get hot at different times. For example, in a particular operating mode or when operating a particular application, the one or more processors (104) may generate the most thermal energy within the electronic device 100. By contrast, when sending and receiving large amounts of data, the communication circuit (106) may generate a greater amount of heat relative to the other components within the electronic device. When charging, an energy storage device or battery may generate the most heat. Advantageously, in one or more embodiments the mechanical actuator 1008 can translate the fan 303 to these locations as a function of the application or operating mode to facilitate maximum thermal dissipation.

Turning now to FIG. 12, illustrated therein is a modular electronic device system 1200. Embodiments of the disclosure contemplate that electronic device systems can be constructed from an electronic device module 1201 that can be selectively attached to one or more accessory modules. In this illustrative embodiment, the accessory module 1202 is an audiophile module that includes a high fidelity loudspeaker 1203.

When the accessory module 1202 is coupled to the electronic device module 1201, rather than using a low fidelity loudspeaker for audio playback, the electronic device module 1201 delivers acoustic signals to the accessory module 1202 so that music can be played through the high fidelity loudspeaker 1203. This is just one example of an accessory module to illustrate how embodiments of the disclosure can be used with modular electronic device systems 1200. If, for example, a user was a photographer rather than a music enthusiast, they may select an accessory module that includes a high resolution camera with a large lens. If the user is both audiophile and photographer, they may interchange accessory modules as desired, and so forth.

The back side of the electronic device module 1201 can include one or more alignment features configured and placed to mate with mating features on the accessory module 1202. Alternatively, any other suitable system may be used to align the electronic device module 1201 and the accessory module for selective attachment and to retain them together can be used. For data communication between the devices, the electronic device module 1201 can include a connector array. The connector array may be located and configured to mate with a mating connector array on the accessory module 1202.

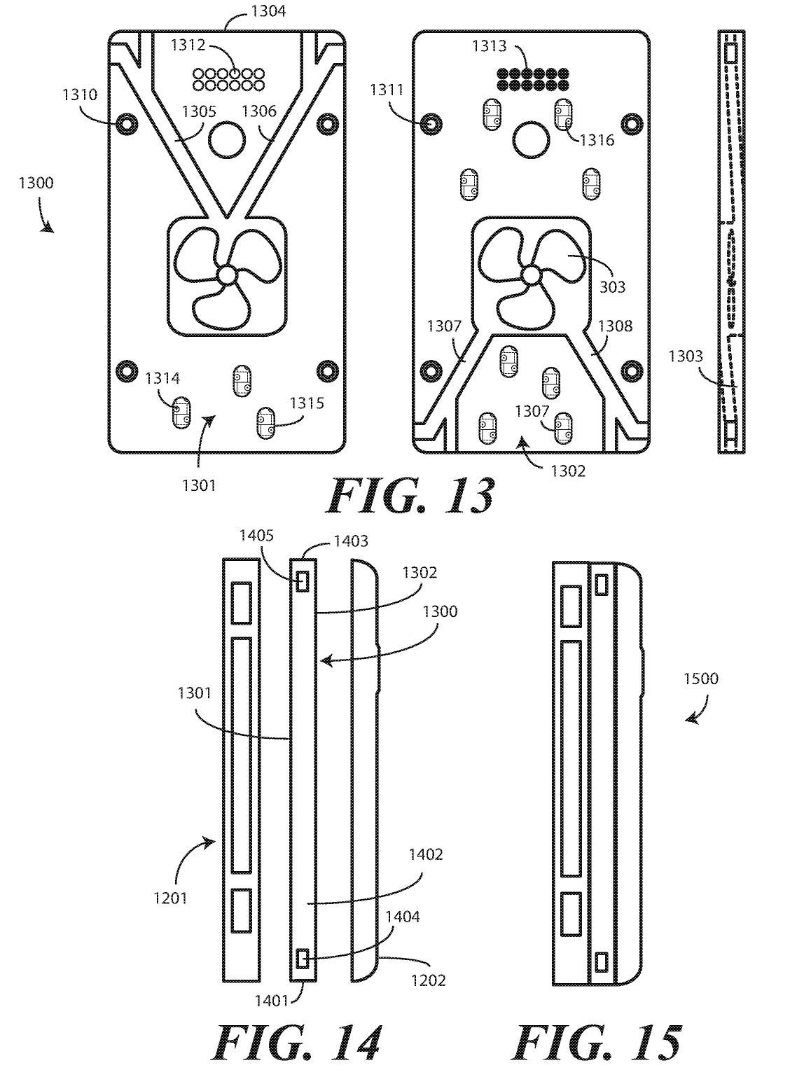

Turning now to FIG. 13, illustrated therein is an attachment 1300 suitable for use with the modular electronic device system (1200) of FIG. 12. Rather than attaching to an outer major face of an electronic device, as was the case in preceding figures, the attachment 1300 of FIG. 13 is suitable for being coupled between an electronic device module and an accessory module.

In FIG. 13, a first major face 1301, a second major face 1302, and a minor face of the attachment 1300 is shown. The attachment 1300 is selectively attachable between an electronic device module and an accessory module. The accessory includes a housing 1304 that carries a thermal energy mitigation device, which is illustrated here as a fan 303. The housing 1304 of this illustrative embodiment defines one or more ducts 1305,1206,1307,1308 through which the fan may draw or push air to dissipate thermal energy incident generated by components disposed within the electronic device module or the accessory module.

In the illustrative embodiment of FIG. 13, both the first major face 1301 and the second major face 1302 include one or more alignment features 1310,1311 configured and placed to mate with complementary mating features disposed along either a surface of an electronic device module or an accessory module In one or more embodiments, the alignment features 1310,1311 and complementary mating features are magnetic. However, other alignment and mating features may be substituted.

In this illustrative embodiment, the first major face 1301 includes a connector array 1312. The second major face 1302 has also included a connector array 1313, which is complementary to the connector array 1312 in this embodiment. The connector array 1312 is located and configured to mate with a mating connector array on an electronic device module, while the other connector array 1313 is configured to mate with a mating connector array on an accessory module. Electrical signals can be delivered both to the attachment 1300 and between the electronic device module the accessory module using the connector array 1312 and the other connector array 1313. Accordingly, the connector array 1312 and the other connector array 1313 can define an electrical conduit to transmit electronic signals between, for example, one or more processors of an electronic device module (1201) and a second attachment attached to the attachment 1300, namely, an accessory module (1202).

As with the embodiment o FIG. 11, the attachment 1300 includes a control circuit (1004) that is operable with one or more thermal energy sensors 1314,1315,1316,1317. In this embodiment, the thermal energy sensors 1314,1315,1316,1317 are distributed across the first major face 1301 and the second major face 1302 of the housing 1304 to define an array. The thermal energy sensors 1314,1315,1316,1317 can be strategically distributed so as to correspond to locations of heat generating components disposed within the electronic device module or the accessory module. Moreover, in one or more embodiments, since heat generating components of the electronic device module and the accessory module will be in different locations, the array disposed along the first major face 1301 will be different from the array disposed along the second major face 1302.

Each thermal energy sensor 1314,1315,1316,1317 is operable with the control circuit (1004) to deliver signals to the control circuit (1004) indicating how much thermal energy each thermal energy sensor 1314,1315,1316,1317 is receiving. In effect, the front side array disposed along the first major face 1301 detects where a highest thermal energy amount occurs in the electronic device module, while the rear side array disposed along the second major face detects where a highest thermal energy amount occurs in the accessory module.

Based upon this information, the control circuit (1004) can cause the fan 303 to draw air through the ducts 1305,1306,1307,1308 to cool the system. Note that while only one fan 303 is shown in FIG. 13, multiple fans can be included in different locations to cool, for example, one particular location on the electronic device module and another location on the accessory module. The same is true with any of the embodiments disclosed herein. While one fan or thermal energy mitigation device is shown for simplicity, multiple thermal energy mitigation devices or fans can be disposed at different locations along the housing to provide enhanced cooling.

Turning now to FIG. 14, as shown, the attachment 1300 is designed to be coupled between an electronic device module 1201 and an accessory module 1202. In this system, the accessory module 1202 effectively becomes a “second attachment” that attaches to the attachment 1300, which attaches to the electronic device module 1201. Since the attachment 1300 is in effect “sandwiched” between the electronic device module 1201 and the accessory module 1202, the way air is drawn through the attachment 1300 to cool the electronic device module 1201 and the accessory module 1202 is different from previous embodiments. Rather than drawing air through a major face and then expelling it through a minor face, in this embodiment, the fan (303) draws air into one minor face and out another minor face.

As shown in FIG. 14, the first major face 1301 of the attachment 1300 is configured to attach to a major face of the electronic device module 1201. Similarly, the second major face 1302 of the attachment 1300 is configured to attach to a major face of the accessory module 1202. These components are coupled together as an assembly 1500 in FIG. 15.

Turning back to FIG. 14, this leaves—in this embodiment—four minor faces 1401,1402,1403 (a fourth minor face is disposed opposite minor face 1402 into the page) exposed with ports 1404,1405 through which air can be drawn or expelled. Since these faces are exposed, the fan (303) dissipates thermal energy by drawing the air into the housing through the first minor face, e.g., minor face 1401, and pushing the air out of the housing through the second minor face, e.g., minor face 1403. In addition, the air can further be drawn in and out of a common minor face. For example, air may be drawn into minor face 1402 through port 1404 and out minor face 1402 through port 1405, for example Of course, a combination of minor faces through which air is drawn in and out of the attachment 1300 can be used as well. For instance, air may be drawn in minor face 1402 through port 1404 and out of the fourth minor face through a port corresponding to port 1405. One illustrative airflow path is shown in FIG. 13 in dashed line. Others will be obvious to those of ordinary skill in the art having the benefit of this disclosure.

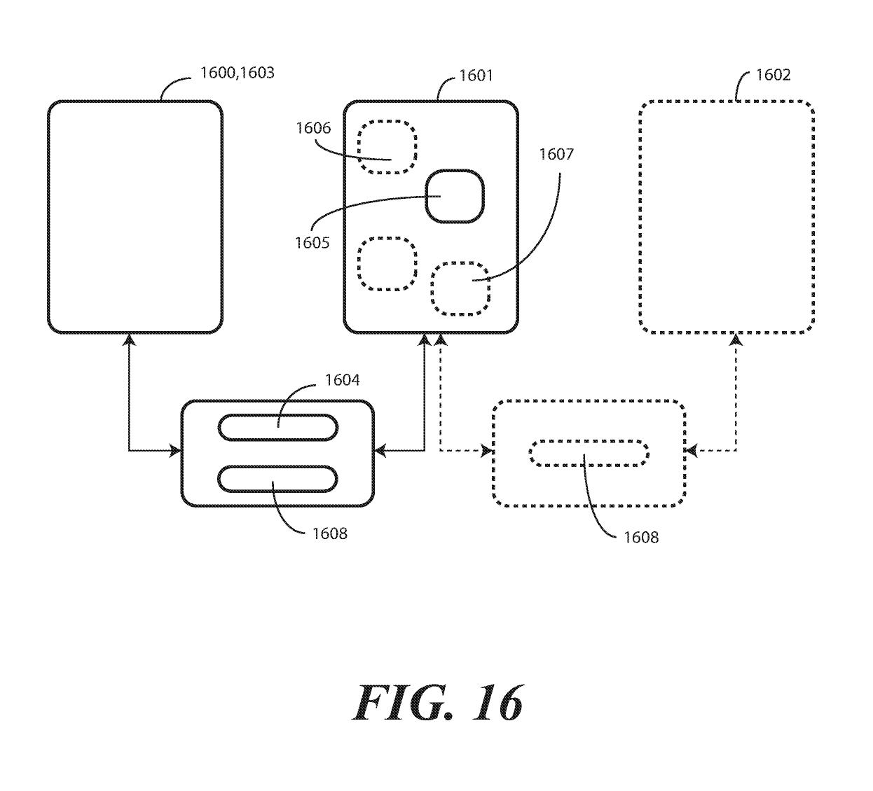

Turning now to FIG. 16, illustrated therein is a schematic block diagram of one or more systems in accordance with one or more embodiments of the disclosure where an attachment 1601 includes electrical connections with another device. FIG. 16 is provided to illustrate some of the signal flows that can occur in one or more embodiments of the disclosure where this is the case. FIG. 16 illustrates systems in which an attachment 1601 is attached to an electronic device 1600, or alternatively when an attachment 1601 is disposed between an electronic device module 1603 and an accessory module 1602.

The first set of signals 1604 is communicated between the electronic device 1600 or electronic device module 1603 and the attachment 1601 and concern the actuation of the thermal mitigation device 1605 or thermal mitigation devices 1605,1606,1607 where multiple thermal mitigation devices 1605,1606,1607 are included.

For example, where the electronic device 1600 includes a temperature sensor, the first set of signals 1604 can include signals from the temperature sensor indicating that the thermal energy exceeds a predefined threshold. Alternatively, the first set of signals 1604 may indicate that a temperature of a predefined component of the electronic device 1600 exceeds another predefined threshold. In either or both cases, the thermal mitigation device 1605 or thermal mitigation devices 1605,1606,1607 can then be actuated to dissipate the thermal energy in response to the first set of signals 1604.

The first set of signals 1604 can be used in other ways as well to actuate the thermal mitigation device 1605 or thermal mitigation devices 1605,1606,1607. For example, when a predefined application is operating in the electronic device 1600 that requires large amounts of processing power, the first set of signals 1604 may request that the thermal mitigation device 1605 or thermal mitigation devices 1605,1606,1607 be actuated to dissipate the thermal energy being generated. Similarly, when the electronic device 1600 is operating in a predefined mode of operation, the first set of signals 1604 may request that the thermal mitigation device 1605 or thermal mitigation devices 1605,1606,1607 actuate to dissipate the thermal energy being generated. Other uses for the first set of signals 1604 will be obvious to those of ordinary skill in the art having the benefit of this disclosure. For example, where the attachment 1601 carries an accessory, such as a camera, loudspeaker, or other device as previously described, the first set of signals 1604 can also be used to control these accessory devices.

The second set of signals 1608 is used when the attachment 1601 is coupled between an electronic device module 1603 and an accessory module 1602. The second set of signals 1608, which is effectively passed through the attachment 1601, can be used to control accessories on the accessory module 1602. Examples of such accessories include microphones, loudspeakers, earpiece speakers, displays, cameras, accessory jacks, and other components. Still other accessories will be obvious to those of ordinary skill in the art having the benefit of this disclosure.

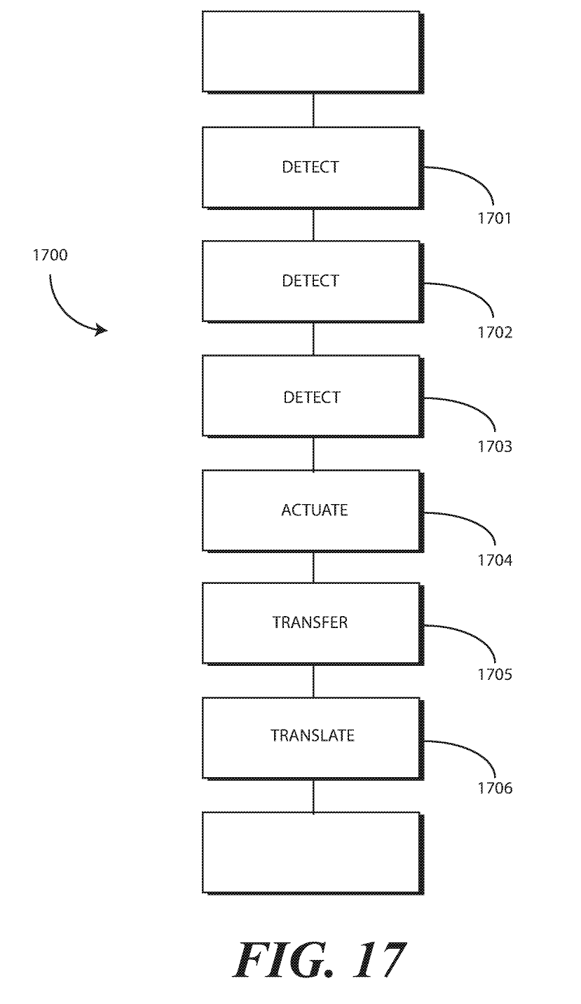

Turning now to FIG. 17, illustrated therein is one explanatory method 1700 in accordance with one or more embodiments of the disclosure. Beginning at step 1701, a control circuit of an attachment that includes at least one thermal energy sensor and at least one thermal energy mitigation device, detects that it is attached to an electronic device or an electronic device module. This can occur in one of a variety of ways. In a first embodiment, the at least one thermal energy sensor simply detects heat from the electronic device or the electronic device module, thereby alerting the control circuit to the fact that it is attached to an electronic device or electronic device module. In another embodiment, the attachment includes an electrical connector and receives signals from the electronic device alerting the control circuit to the fact that it is coupled to an electronic device or an electronic device module. Other techniques, such as using Hall effect sensors, spring contacts, wireless communication, and so forth, can be used as well. Still other techniques will be obvious to those of ordinary skill in the art having the benefit of this disclosure.

At step 1702, at least one thermal energy sensor detects thermal energy exceeding a predefined threshold. In one embodiment, as shown at optional step 1703, at least one thermal energy sensor further detects a location at which the temperature exceeds the predefined threshold.

At step 1704, the control circuit actuates the thermal mitigation device to dissipate energy from the electronic device or the electronic device module. Where the attachment is disposed between an electronic device module and an accessory module or “second attachment,” step 1704 can include actuating the thermal mitigation device to dissipate energy from both the electronic device and the accessory module. Additionally, the attachment is disposed between an electronic device module and an accessory module, optional step 1705 can be included where electronic signals are transferred to and from the electronic device module and the accessory module through the attachment.

In one or more embodiments, the thermal mitigation device is movable along the attachment, either manually or by way of a mechanical actuator such as a motor. Where this is the case, optional step 1706 can include translating the at least one thermal energy mitigation device to the location along the electronic device where the temperature exceeds the predefined threshold.

In the foregoing specification, specific embodiments of the present disclosure have been described. However, one of ordinary skill in the art appreciates that various modifications and changes can be made without departing from the scope of the present disclosure as set forth in the claims below. Thus, while preferred embodiments of the disclosure have been illustrated and described, it is clear that the disclosure is not so limited. Numerous modifications, changes, variations, substitutions, and equivalents will occur to those skilled in the art without departing from the spirit and scope of the present disclosure as defined by the following claims. For example, while one fan or thermal mitigation device was shown for simplicity in most embodiments, multiple fans or thermal mitigation devices, such as those shown in FIG. 16, could be included in other embodiments as well.

Accordingly, the specification and figures are to be regarded in an illustrative rather than a restrictive sense, and all such modifications are intended to be included within the scope of present disclosure. The benefits, advantages, solutions to problems, and any element(s) that may cause any benefit, advantage, or solution to occur or become more pronounced are not to be construed as a critical, required, or essential features or elements of any or all the claims. The disclosure is defined solely by the appended claims including any amendments made during the pendency of this application and all equivalents of those claims as issued.

What is claimed is:

1. An attachment for an electronic device, the attachment comprising:
a housing, selectively attachable to the electronic device by one or more coupling devices;
at least one thermal energy mitigation device, carried by the housing;
at least one thermal energy sensor, carried by the housing; and
a control circuit, operable with the at least one thermal energy mitigation device and the at least one thermal energy sensor, the control circuit causing the at least one thermal energy mitigation device to dissipate thermal energy incident upon the housing in response to signals from the at least one thermal energy sensor.

2. The attachment of claim 1, wherein the at least one thermal energy mitigation device comprises at least one fan.

3. The attachment of claim 2, the housing defining one or more ducts through which the at least one fan may draw or push air to dissipate the thermal energy.

4. The attachment of claim 3, the housing defining at least one major face and at least one minor face, the at least one fan dissipating the thermal energy by drawing the air into the housing through the at least one major face and pushing the air out of the housing through the at least one minor face.

5. The attachment of claim 4, the signals indicating that the thermal energy exceeds a predefined threshold.

6. The attachment of claim 5, the signals further indicating that a predefined application is operating in the electronic device.

7. The attachment of claim 5, the signals further indicating an operating mode of the electronic device.

8. The attachment of claim 5, the signals further indicating a temperature of a predefined component of the electronic device exceeds another predefined threshold.

9. The attachment of claim 4, wherein the at least one fan is selectively movable within the housing between at least a first location and at least a second location.

10. The attachment of claim 9, further comprising a mechanical actuator, carried by the housing, the mechanical actuator translating the at least one fan between the at least the first location and the at least the second location in response to the signals from the at least one thermal energy sensor.

11. The attachment of claim 10, the at least one thermal energy sensor comprising an array of thermal energy sensors, the signals identifying which one or more thermal energy sensors of the array of thermal energy sensors detect a highest thermal energy amount, the at least a second location substantially collocated with the one or more thermal energy sensors.

12. The attachment of claim 3, the housing comprising a first major face that is selectively attachable to the electronic device and a second major face, further comprising another attachment coupled to the second major face.

13. The attachment of claim 12, the housing further comprising a first minor face and a second minor face, the at least one fan dissipating the thermal energy by drawing the air into the housing through the first minor face and pushing the air out of the housing through the second minor face.

14. A system, comprising:
an electronic device comprising a housing and one or more processors; and
an attachment that is selectively attachable to the electronic device by one or more coupling devices, the attachment comprising at least one thermal energy mitigation device;
the one or more processors selectively actuating the at least one thermal energy mitigation device to dissipate thermal energy generated by the electronic device.

15. The system of claim 14, the one or more processors selectively actuating the at least one thermal energy mitigation device as a function of one of an operating mode of the electronic device or an application operating on the one or more processors.

16. The system of claim 14, the attachment further comprising at least one thermal energy sensor and at least one control circuit, the at least one control circuit capable of independently actuating the at least one thermal energy mitigation device in response to signals from the at least one thermal energy sensor.

17. The system of claim 14, further comprising a second attachment, wherein the attachment is disposed between the electronic device and the second attachment, further wherein the attachment comprises a first minor face and a second minor face, the at least one thermal energy mitigation device dissipating the thermal energy by drawing air into the first minor face and pushing the air out through the second minor face.

18. The system of claim 17, the attachment further comprising an electrical conduit to transmit electronic signals between the one or more processors and the second attachment.

19. A method, comprising:
detecting, by an attachment comprising at least one thermal energy sensor, at least one thermal energy mitigation device, and at least one control circuit, coupling of the attachment to an electronic device;
determining, by the at least one thermal energy sensor, a temperature at a location along the electronic device exceeding a predefined threshold; and
actuating, by the at least one control circuit, the at least one thermal energy mitigation device to dissipate thermal energy from the electronic device.

20. The method of claim 19, further comprising translating, with a mechanical actuator, the at least one thermal energy mitigation device to the location along the electronic device where the temperature exceeds the predefined threshold.
